(19) United States
(12) Patent Application Publication
(10) Pub. No.: US 2009/0026231 A1
(43) Pub. Date: Jan. 29, 2009

(54) Valves for drinking cups

(76) Inventor: David Goodwin, Surrey (GB)

Correspondence Address: Olson & Cepuritis, LTD., 20 NORTH WACKER DRIVE, 36TH FLOOR, CHICAGO, IL, 60606, US

(21) Appl. No.: 11/666,047

(22) PCT Filed: Oct. 13, 2005
(86) PCT No.: PCT/GB2005/003951

§ 371 Date: Apr. 14, 2008

(30) Foreign Application Priority Data
Oct. 19, 2004 (GB) 0423160.1

(51) Int. Cl. B67D 3/00

(52) U.S. Cl. 222/514

(57) ABSTRACT

A valve for a bottle or a bottle cap comprises a fluid delivery tube having an inlet and an outlet, the tube being moveable between a first position where fluid cannot enter the tube and a second position where fluid can enter the tube and means for urging the tube to the first position, wherein the tube is moveable to said second position by means of force applied in opposition to the urging means.

### FIELD OF THE INVENTION

This invention concerns valves for drinking cups for use particularly by infants.

### BACKGROUND OF THE INVENTION

Drinking cups having a cap with a spout towards one side thereof are available for use by infants. These spouts are usually wide and narrow and have two or more holes therein. A problem with these drinking cups is that they leak when not handled correctly, which is often the case with infants due to lack of controllability or carelessness.

An object of this invention is to provide a drinking cup that is less prone to leakage.

### SUMMARY OF THE INVENTION

According to the invention, a valve is provided that can be incorporated in drinking bottles or in caps for drinking bottles, whereby fluid flow from the bottle through the valve is permitted by application of pressure or force onto a valve component, especially a fluid delivery tube of the valve.

In a preferred embodiment, a valve for a bottle or a bottle cap comprises a fluid delivery tube having an inlet and an outlet, the tube being moveable between a first position where fluid cannot flow through the tube and a second position where fluid can flow through the tube, and means for urging the tube to its first position, wherein the tube is moveable to its second position by application of force in opposition to the urging means.

When the valve is incorporated in a bottle cap, the cap may be mountable on the bottle or may be formed integrally with the bottle.

The inlet of the delivery tube is preferably in a side of the tube and the outlet of the delivery tube is preferably at an end of the tube.

The delivery tube is preferably moveable in a nozzle or the like of the bottle cap. Preferably the delivery tube is slidable within the nozzle. The inlet of the tube is preferably closed by an inner wall of the nozzle.

In preferred embodiments of the invention, the delivery tube is preferably shaped to be a push fit through the nozzle for assembly of the valve. The valve preferably includes means for retaining the tube in the nozzle. The preferred retaining means comprises one or more stops on the tube for abutment against an end of the nozzle. The stops are preferably at one end of the tube. The stops are preferably tapered to facilitate insertion through the nozzle.

The preferred means for urging the tube to the first position comprises spring means. The spring means may be formed integrally with a part of the valve, especially with the delivery tube or a part associated therewith.

In one preferred embodiment of the invention, the spring means comprises a resilient skirt. In another preferred embodiment, the spring means comprises one or more resilient coilable rods. The coilable rods preferably depend from a flange or the like extending outwardly from an upper end of the delivery tube, whereby abutment of the free ends of the rods causes them to coil to form springs for urging the delivery tube to its first position. To facilitate the coiling action of the rods, the valve may include ramps against which the free ends of the rods abut.

In yet another preferred embodiment of the invention, the spring means is formed integrally between the delivery tube and another part of the valve. Preferably the spring means comprises a resilient hinge between the delivery tube and another part of the valve. The other part of the valve is preferably a nozzle for the delivery tube.

Alternatively, the spring means may comprise a separate spring member, such as a helical spring around the delivery tube outlet between an abutment of the tube and another part of the valve. The other part of the valve may be associated with a nozzle for the delivery tube.

In preferred embodiments of the invention, the valve may include means for pressure equalization in the bottle. Thus, the delivery tube may have an additional passage for allowing air back into the bottle.

To facilitate the application of force to the delivery tube to move it to its second position, the delivery tube preferably has a peripheral flange.

### BRIEF DESCRIPTION OF THE DRAWINGS

This invention will now be further described, by way of example only, with reference to the accompanying drawings, in which:

FIG. 1 shows a cap for a bottle before assembly into working condition;

FIG. 2 is a section through the cap of FIG. 1;

FIG. 3 shows the cap in working condition;

FIG. 4 is a section through the cap in working condition;

FIG. 5 is a section through a second valve of the invention in closed condition;

FIG. 6 shows the valve of FIG. 5 in open condition;

FIG. 7 shows a third embodiment of the invention;

FIG. 8 shows a fourth embodiment of the invention; and

FIG. 9 shows a fifth embodiment of the invention.

### DETAILED DESCRIPTION OF PREFERRED EMBODIMENTS

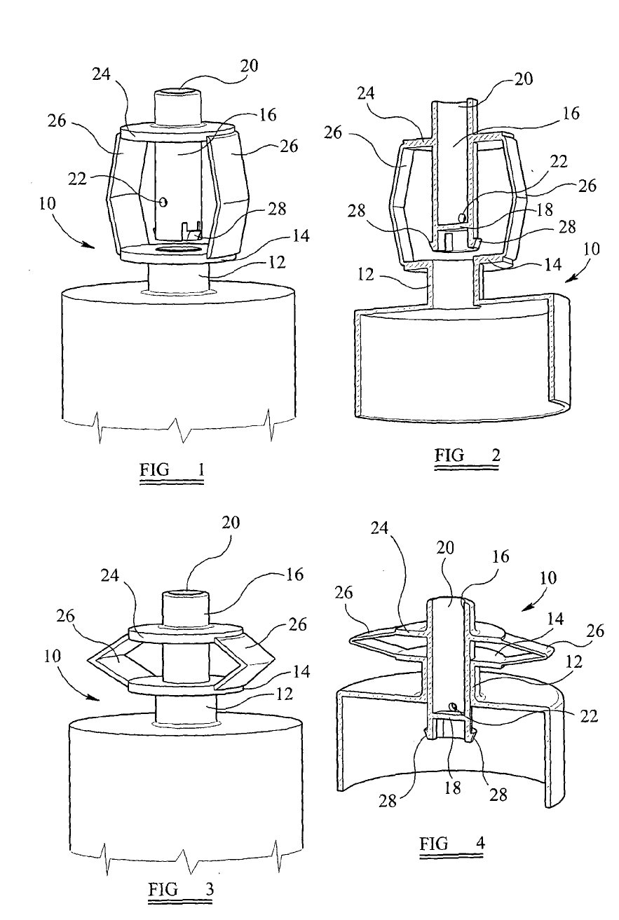

Referring to FIGS. 1 to 4 of the accompanying drawings, a cap 10 for a fluid-containing bottle has a nozzle 12 extending therefrom. The nozzle 12 has a flange 14 about its free end. Within the nozzle 12, a fluid delivery tube 16 is reciprocally slidable. The delivery tube 16 is a fluid-tight fit within the nozzle 12. The delivery tube 16 is closed near its bottom end by a plug 18 but is open at its top end 20. A small hole 22 is located just above the plug 18.

The delivery tube 16 itself has a flange 24 around its periphery spaced from its free end 20. The flanges 14 and 24 are connected at opposite sides by resilient hinges 26.

At its lower end, the delivery tube 16 has a pair of stops 28 on its outside. The stops 28 taper inwardly and downwardly, so that the delivery tube 16 can be fitted into the nozzle 12 with the stops 28 inside the cap 10 but cannot be easily pulled out of the cap.

The cap 10 can be conveniently molded in one piece and can include a screw-threaded inner wall for screw-threaded attachment to a bottle. Once the cap has been molded, the delivery tube is pushed into the nozzle until the stops 28 are though the nozzle.

The cap 10 operates in the following manner. After molding in one piece, the delivery tube 16 is pushed into nozzle 12, so that the stops 28 are below the top of the cap. The resilient hinges 26 act to urge the delivery tube 16 upwardly, so that the stops 28 abut the underside of the cap 10. In this position, the small hole 22 is within the nozzle 12, so that no fluid from the bottle can pass through the small hole into the delivery tube. When a drink is to be taken from the bottle, the delivery tube 16 is pushed downwards into the bottle, so that the small hole 22 is clear of the nozzle for fluid to enter the hole and pass through the delivery tube.

Turning to FIGS. 5 and 6 of the accompanying drawings, there is shown an alternative embodiment of the invention, in which a cap 50 and delivery tube 52 are not formed integrally. Instead, the cap 50 has a nozzle 54 with a smaller flange 56 than the previous embodiment. The delivery tube 52 is basically the same in form as that of the previous embodiment except that it is not connected to the cap by resilient hinges. It does have a peripheral flange 58. Instead, there is a helical compression spring 60 around the delivery tube 52 between the flange 56 of the cap nozzle and the flange 58 of the delivery tube.

This embodiment operates in a similar fashion to that of the previous embodiment. The cap is assembled by fitting the helical spring around the delivery tube and then pushing the tube through the nozzle with the spring trapped between the flanges 56 and 58, until the stops at the end of the delivery tube are through the nozzle. The spring 60 urges the delivery tube 52 upwards, so that the wall of the nozzle 54 closes the small hole 62 in the delivery tube. When fluid is to be withdrawn from the bottle, pressure is applied to the delivery tube 52 to push it into the bottle, which makes the small hole 62 accessible to the fluid contents of the bottle, so that they can pass through to the delivery tube. Pressure will typically be applied to the flange 58 of the delivery tube by a user's lips acting on the flange of the tube.

In FIG. 7 of the accompanying drawings, another embodiment of the invention is shown which is a two-part construction. A bottle cap 100 has a top wall 102 that has a nozzle 104 extending through it. At its top the nozzle has a lead-in part 106 with divergent sides. At its bottom end 108, the nozzle has an internal annular lip 110 with a downwardly sloping top surface 112. The nozzle 104 is situated in and surrounded by a depressed region 114 of the top wall of the cap. The depressed area 114 has a side wall 116 that includes a sloping portion 118.

Reciprocally slidable in the nozzle 104 is a delivery spout 120 that comprises a delivery tube 122 surrounded by a flange 124 at its top end that has a depending skirt 126. The skirt 126 is slightly divergent over a major portion of its length but has a bottom portion 128 that flares outwardly more sharply. This bottom portion 128 forms an integral spring which has its edge 130 seated against the side wall 116 of the depressed region 114 and on top of the sloping part 118.

The delivery tube 122 has its bottom end 132 closed and also has an annular lip 134. The lip 134 has its underside 136 rounded to facilitate insertion of the delivery tube 122 into the nozzle 104 until the lip passes through the nozzle. The delivery tube 122 also has a hole 138 in its side spaced from its bottom end.

The spring 128 holds the delivery tube 122 in a position where the lip 134 abuts the underside of the nozzle so that the inner wall 140 of the nozzle closes the hole 138 in the side of the delivery tube. To permit fluid to be drawn from the bottle, the delivery tube 122 has to be depressed so that it extends through the nozzle 104 to an extent that the hole 138 in the side wall of the delivery tube is open into the bottle for fluid from the bottle to pass into the delivery tube. The delivery tube can be depressed by pressure from the lips of the user on the top of the spout.

Turning to FIG. 8 of the accompanying drawings, another cap 148 of the invention is in two-part form having a delivery tube 150 with a skirt 152 similar to that of the previous embodiment except that there is no flared bottom part to the skirt. The delivery tube 150 extends through a nozzle 154 in the same way as the previous embodiment.

To provide the spring means for holding the delivery tube 150 in a closed position, the cap 148 has internally a pair of depending resilient rods 156 formed integrally with the cap. Each rod 156 meets a ramp 158 in a depression 160 in the top of the cap, the ramps 158 being oppositely orientated, so that when downwards pressure is applied to the delivery tube 150, the rods 156 coil in opposite directions to form coil springs. The coil springs thus formed urge the delivery tube 150 to a closed position, once downward pressure is released.

In the above embodiments, it is believed that the valve equalizes pressure on the opening or closing stroke. The valve admits a portion of air, which helps to control fluid flow. An infant cannot then drink continuously, which is perceived as being bad for teeth (e.g., by leading to tooth decay from sweet drinks) and has to stop to allow the valve to close for air ingress.

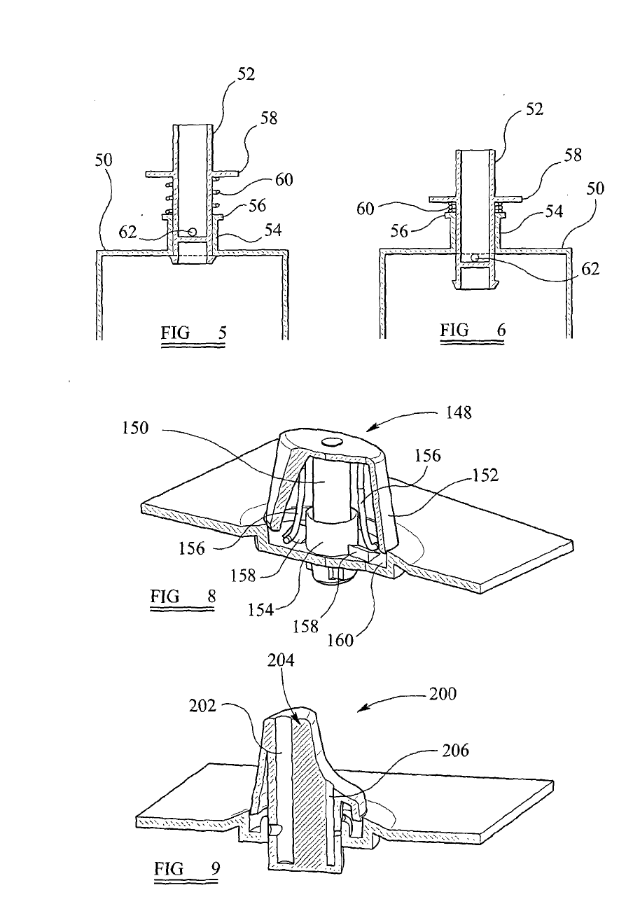

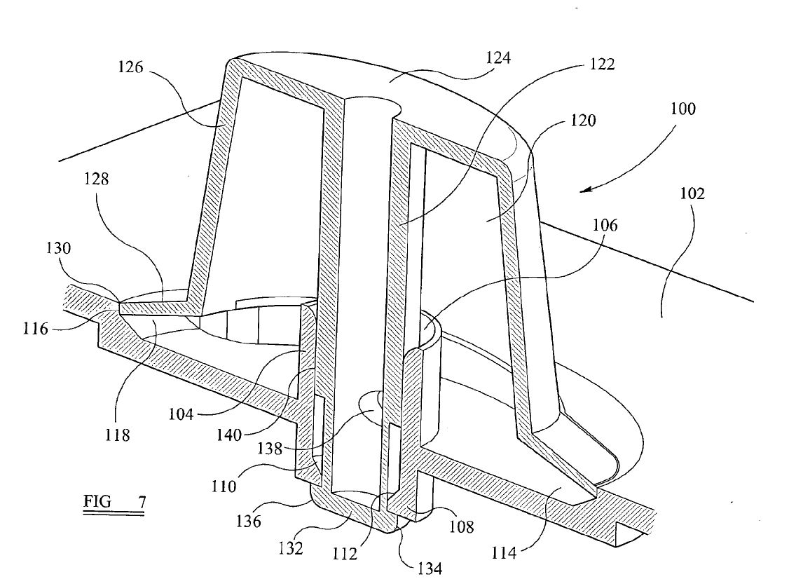

Finally, in FIG. 9, another cap 200 according to the invention is shown to illustrate the provision of specific pressure equalization means, so that as fluid is removed from the bottle, it can be replaced by air. In this embodiment, the actual spring means for urging delivery tube 202 to a closed position is not shown.

The delivery tube 202 is off-center in a delivery spout 204 that has a secondary tube 206 to allow air to return to a bottle on which the cap is fitted. The delivery tube has the same general form as in previous embodiments. The secondary tube is narrower than the delivery tube 202 and has an inlet at one end and an outlet part way along its length, so that when the delivery tube is in a closed position the secondary tube is also closed and vice versa.

While the invention has been described with reference to drinking bottles for use particularly by infants, it will be appreciated that the valve arrangements of the invention may be useful for other bottles or containers for the delivery of fluids including, for example, carbonated drink bottles.

What is claimed is:

1. A valve for a bottle or a bottle cap comprising:
a fluid delivery tube having an inlet and an outlet, the tube being moveable between a first position where fluid cannot enter the tube and a second position where fluid can enter the tube; and
means for urging the tube to the first position, wherein the tube is moveable to said second position by means of force applied in opposition to said urging means.

2. The valve as claimed in claim 1, wherein the cap is mountable on the bottle.

3. The valve as claimed in claim 1, wherein the cap is formed integrally with the bottle.

4. The valve as claimed in claim 1, wherein the inlet is in a side of the tube.

5. The valve as claimed in claim 1, wherein the outlet is at an end of the tube.

6. The valve as claimed in claim 1, wherein the tube is moveable in a nozzle or the like.

7. The valve as claimed in claim 6, wherein the inlet of the tube is closed by an inner wall of the nozzle.

8. The valve as claimed in claim 6, wherein the tube is shaped to be a push-fit through the nozzle.

9. The valve as claimed in claim 6, further including means for retaining the tube in the nozzle.

10. The valve as claimed in claim 9, wherein said retaining means comprises one or more stops on the tube for abutment against an end of the nozzle.

11. The valve as claimed in claim 10, wherein the ring is at one end of the tube.

12. The valve as claimed in claim 1, wherein the means for urging the tube to said first position comprises spring means.

13. The valve as claimed in claim 12, wherein the spring means is formed integrally with a part of the valve.

14. The valve as claimed in claim 13, wherein the spring means is formed integrally with the delivery tube or a part associated therewith.

15. The valve as claimed in claim 14, wherein the spring means comprises a resilient skirt.

16. The valve as claimed in claim 14, wherein the spring means comprises one or more resilient coilable rods.

17. The valve as claimed in claim 13, wherein the spring means is formed integrally between the delivery tube and another part of the valve.

18. The valve as claimed in claim 17, wherein the spring means comprises a resilient hinge between the dispensing tube and another part of the valve.

19. The valve as claimed in claim 18, wherein the other part of the valve is a nozzle for the delivery tube.

20. The valve as claimed in claim 12, wherein the spring means comprises a separate spring member.

21. The valve as claimed in claim 20, wherein the separate spring member is a helical spring around the delivery tube outlet between an abutment of the tube and another part of the valve.

22. The valve as claimed in claim 21, wherein the other part of the valve is associated with a nozzle for the tube.

23. The valve as claimed in claim 1, wherein the delivery tube includes means for allowing air entry for pressure equalization with the bottle.

24. The valve as claimed in claim 1, wherein the dispensing tube includes a peripheral flange.

25. A cap for a bottle including a valve as claimed in claim 1.

26. A bottle including a valve as claimed claim 1.

27. A bottle including a cap as claimed in claim 25.
